(19) United States
(12) Patent Application Publication
(10) Pub. No.: US 2002/0143550 A1
(43) Pub. Date: Oct. 3, 2002

(54) Voice recognition shopping system

(76) Inventor: Takashi Nakatsuyama, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/818,413

(22) Filed: Mar. 27, 2001

(51) Int. Cl. G10L 11/00

(52) U.S. Cl. 704/270.1

(57) ABSTRACT

A computer system and method for providing a voice-recognition-based Internet shopping interface between an end user's Internet-enabled device (e.g., an Internet-enabled Personal Digital Assistant [PDA], an Internet-enabled personal computer [PC], an Internet-enabled cellular phone or an interactive television) and online shopping sites. The computer system includes a server computer with an agent interface, dialog editor, text-to-voice converter and dialog interpreter interface. The agent interface employs voice-format shopping site questions delivered via the end user's Internet-enabled device to determine the end user's online shopping site requirements. The dialog editor is used to generate and store a series of text-format product questions, expected answers, associated actions to be taken and target products for each of the online shopping sites. The dialog interpreter interface employs voice-format product questions (delivered via the end user's Internet-enabled device and created from the text-format product questions by the text-to-voice converter) to determine the end user's product requirements and a target product that meets those requirements. The voice-recognition-based Internet shopping interface can also be configured to provide a life-like and entertaining environment for the end user by displaying agent character images and clerk character images that accompany the voice-format shopping site questions and voice-format product questions, respectively. The method includes providing a server computer with a dialog editor, an agent interface and a dialog interpreter interface. The method determines an end user's online shopping site requirements and product requirements via voice-format shopping site questions, voice-format product questions and the end user's voice-format answers thereto.

### BACKGROUND OF THE INVENTION

1. Field of the Invention

The present invention relates in general to computer systems and their associated methods and, in particular, to computer systems and methods for providing Internet shopping interfaces.

2. Description of the Related Art

End user browsing and purchasing of retail products (i.e., shopping) via the Internet has become commonplace. When shopping via the Internet, an end user (i.e., a customer) typically interacts with a retailer's online shopping site through an Internet shopping interface. Conventional shopping interfaces, including those that employ the Internet, are based on providing text-format information organized along broad product and/or keyword categories, in combination with point-and-click or key pad-type interactions. Consequently, conventional Internet shopping interfaces fail to provide an entertaining and life-like shopping environment for the end user. In addition, the use of broad product and/or keyword categories offers the end user minimal assistance in selecting from among an ever-increasing number of online shopping sites and, thus, requires excessive time to search for and purchase a desired product.

Voice recognition technology (i.e., both text-to-speech and speech-to-text technologies) and methodologies for creating interactive images of characters and scenes have been well developed in recent years. Their conventional implementation requires complex software and a high level of calculation performance that are beyond the capability of most consumer electronics. Individual retailers have, therefore, been precluded from developing and broadly deploying Internet shopping interfaces that employ these technologies.

Still needed in the field, therefore, is a voice-recognition-based Internet shopping interface that can be easily deployed by retailers. In addition, the voice-recognition-based Internet shopping interface should provide a life-like and entertaining environment for the end user and assist the end user in more easily selecting a desired product from among a plurality of online shopping sites.

### BRIEF SUMMARY OF THE INVENTION

The present invention provides a computer system for providing a voice-recognition-based Internet shopping interface between an end user's Internet-enabled device (e.g., an Internet-enabled Personal Digital Assistant [PDA], an Internet-enabled personal computer [PC], an Internet-enabled cellular phone or an interactive television) and a plurality of online shopping sites. The computer system is configured such that a voice-recognition-based Internet shopping interface can be easily deployed by the retailers responsible for each of the plurality of online shopping sites. The computer system employs voice-format shopping site questions and voice-format product questions, presented via the end user's Internet-enabled device, to solicit voice-format answers from an end user. The voice-format answers are used to determine the end user's online shopping site requirements and to determine a suitable target product for purchase from an online shopping site that meets the end user's online shopping site requirements. The voice-recognition-based Internet shopping interface can also be configured to provide a life-like and entertaining environment for the end user by displaying agent character images and clerk character images to accompany the voice-format shopping site questions and voice-format product questions, respectively. Such a display of various images makes online shopping more enjoyable and fun.

One exemplary embodiment of a computer system for providing a voice-recognition-based Internet shopping interface between an end user's Internet-enabled device and a plurality of online shopping sites according to the present invention includes a server computer linked to the Internet. The server computer includes an agent interface, a dialog editor, a text-to-voice converter and a dialog interpreter interface.

The agent interface is configured to present a series of voice-format shopping site questions to an end user via the end user's Internet-enabled device. The agent interface is also configured to receive, via the end user's Internet-enabled device, voice-format answers to the series of voice-format shopping site questions, to convert the voice-format answers to text-format answers using a voice-recognition technology, and to analyze the text-format answers to determine the end user's online shopping site requirements.

The dialog editor is configured to generate and store a series of text-format product questions, associated expected answers, associated actions to be taken and target products for each of the plurality of online shopping sites. The series of text-format product questions, associated expected answers, associated actions to be taken and target products is designed to determine an end user's product requirements. The aforementioned generation can be accomplished, for example, remotely by the retailers responsible for each of the online shopping sites using downloadable dialog editor software. The dialog editor can also be configured such that retailers responsible for each of the online shopping sites can create custom clerk character images.

The text-to-voice converter included in the server computer is configured to convert the text-format product questions, which were generated using the dialog editor, to voice-format product questions.

The dialog interpreter interface is configured to present the end user with voice-format product questions pertaining to an online shopping site that meets the end user's online shopping site requirements via the end user's Internet-enabled device. The dialog interpreter is also configured to receive the end user's voice-format product answers in response to the voice-format product questions and to convert the voice-format product answers to text-format product answers using voice-recognition technology. The dialog interpreter is further configured to analyze the text-format product answers and, thereby, determine the end user's product requirements and a target product that meets those requirements.

Also provided is a method for making available a voice-recognition-based Internet shopping interface between an end user's internet-enabled device and a plurality of online shopping sites. The method includes providing a computer server with a dialog editor, an agent interface, a text-to-voice converter and a dialog interpreter interface. Next, a series of text-format product questions, associated expected answers, associated actions to be taken and target products for each of the plurality of online shopping sites are generated and stored using the dialog editor. The series of text-format product questions, associated expected answers, associated actions to be taken and target products is designed to determine an end user's product requirements.

The computer server is then accessed via the end user's Internet-enabled device and a series of voice-format shopping site questions is presented to the end user (via the end user's Internet-enabled device) using the agent interface. Once the end user's voice-format answers to the voice-format shopping site questions are received at the agent interface, they are analyzed to determine the end user's online shopping site requirements. Online shopping sites that meet such requirements are subsequently introduced to the end user, via the end user's Internet-enabled device, who then selects one among them.

Next, voice-format product questions (which are generated by the text-to-voice converter from the series of text-format product questions) are presented to the end user via the end user's Internet-enabled device, and then the end user's voice-format answers thereto are received at the dialog interpreter. The dialog interpreter analyzes the voice-format answers, using the associated expected answers, associated actions to be taken and target products, to determine the end user's product requirements and a suitable target product that meets those requirements.

A better understanding of the features and advantages of the present invention will be obtained by reference to the following detailed description that sets forth illustrative embodiments in which the principles of the invention are utilized, and the accompanying drawings.

### BRIEF DESCRIPTION OF THE DRAWINGS

FIG. 1 is a block diagram of a computer system for providing a voice-recognition-based Internet shopping interface according to one exemplary embodiment of the present invention;

FIG. 2 is a drawing depicting predetermined software-based forms that can be employed by a dialog generator in a computer system for providing a voice-recognition-based Internet shopping interface according to one exemplary embodiment of the present invention;

FIG. 3 is a drawing depicting a manner by which a dialog editor can generate target products in a computer system for providing a voice-recognition-based Internet shopping interface according to one exemplary embodiment of the present invention;

FIG. 4 is an illustration depicting a branching pathway relationship between text-format product questions, associated answers, associated actions to be taken and target products in a method according to one embodiment of the present invention;

FIG. 5 is an exemplary drawing depicting a custom clerk character image and predetermined clerk character image components; and

FIG. 6 is a flow diagram illustrating a process according to one exemplary embodiment of the present invention.

### DETAILED DESCRIPTION OF THE INVENTION

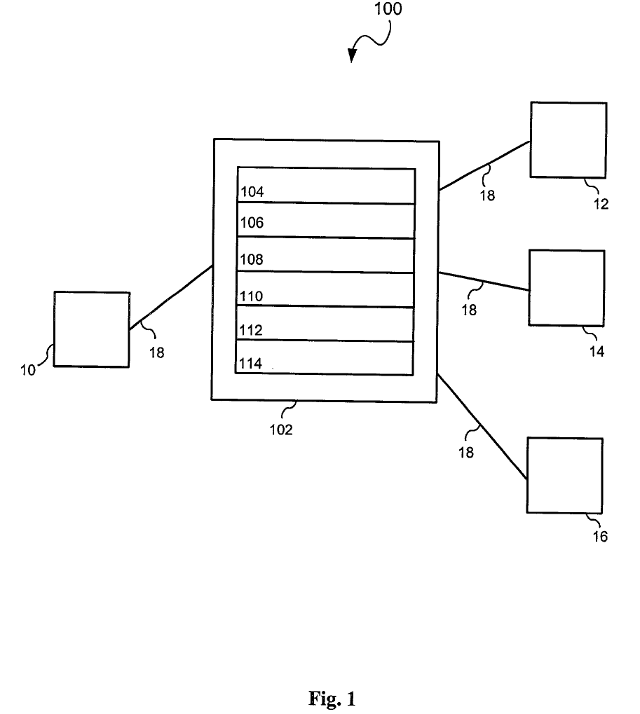

FIG. 1 is a block diagram of a computer system 100 for providing a voice-recognition-based Internet shopping interface according to one exemplary embodiment of the present invention. Computer system 100 provides a voice-recognition-based Internet shopping interface between an end user's Internet-enabled device 10 and a plurality of online shopping sites 12, 14 and 16 via Internet connections 18.

Internet-enabled device 10 can be any device capable of communicating via the Internet, including communication via voice and the display of images (e.g., character images and scene images). Internet-enabled device 10 can be, for example, an Internet-enabled personal digital assistant (PDA), an Internet-enabled personal computer (PC), an Internet-enabled cellular phone, or an interactive television. Online shopping sites 12, 14 and 16 are Internet accessible (i.e., online) shopping sites deployed by various product retailers, such as Amazon.com or Kmart.

The computer system 100 includes a server computer 102 that is linked to the Internet. The server computer 102 can be any suitable server computer known in the art, such as those available from Sun Microsystems or IBM. Server computer 102 includes an agent interface 104, a dialog editor 106, a text-to-voice converter 108, and a dialog interpreter interface 110.

Agent interface 104 is configured to analyze and determine an end user's (i.e., customer's) shopping site requirements. Such analysis and determination are accomplished by presenting the end user with series of voice-format shopping site questions and receiving the end user's voice-format answers thereto. The voice-format shopping site questions are presented and the voice-format answers received via the end user's Internet-enabled device 10 and Internet connections 18. During this question and answer interaction, agent interface 104 also converts the voice-format answers to text-format answers using a voice-recognition technology and analyzes the text-format answers to determine the end user's online shopping site requirements.

The series of voice-format shopping site questions serve to conveniently determine the end user's online shopping site requirements with respect to multiple criteria such as product specifics, price range, payment method, etc. The end user's online shopping site requirements are then used as the bases for compiling a list of online shopping sites that meet such requirements. This can be accomplished, for example, by employing a search engine present within agent interface 104 to search a database (also present within agent interface 104) of available online shopping sites. It should be noted that agent interface 104 does not identify specific target product(s) that an end user may be interested in purchasing, but only determines which specific online shopping sites among the plurality of online shopping sites meet the end user's online shopping site requirements.

To provide the end user with a life-like and entertaining environment, agent interface 104 is also configured to display agent character images and scene images on the end user's Internet-enabled device 10 to accompany the voice-format shopping site questions. The agent character images can include, for example, a predetermined or user selectable agent character image representing the face, body, etc. of a fictional agent that is interacting with the end user by speaking the voice-format shopping site questions.

Agent interface 104 optionally includes agent plug-in software configured to be downloaded from agent interface 104 to the end user's Internet-enabled device 10 by, for example, accessing an agent interface web page via Internet connections 18. The agent plugin software can provide for predetermined agent interface functions to be performed remotely from server computer 102 (e.g., at the end user's Internet-enabled device 10). Such predetermined agent interface functions can include, for example, (i) voice recognition based on a Natural Language Interface (NLI) to convert the end user's voice-format answers to textformat answers; and (ii) a text-to-voice engine function for converting text-format shopping site questions stored in the agent interface to voice-format shopping site questions for presentation to the end user.

Agent interface 104 can also optionally include an agent interface memory for storing an end user's profile (e.g., the end user's address, preferred on-line shopping sites, preferred payment method and preferred price range) and on-line shopping history (e.g., a history of on-line shopping sites with which the end user has interacted). The profile and history can then be used by agent interface 104 as an aid in analyzing and determining an end user's shopping site requirements during the end user's use of computer system 100.

Dialog editor 106 is configured to generate and store a series of text-format product questions, associated expected answers, associated actions to be taken and target products for each of the plurality of online shopping sites. The generation and storage of such information are designed to enable the computer system to determine an end user's specific product requirements and select a suitable target product that meets those requirements for the end user's purchasing consideration.

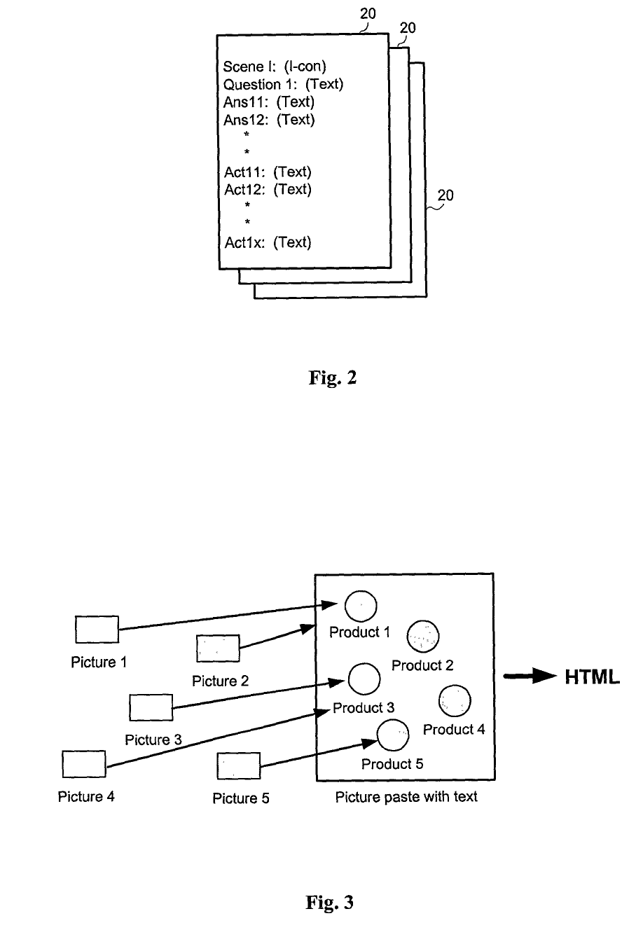

Dialog editor 106 can include interactive dialog editor software that is downloadable to, for example, computer apparatus (e.g., personal computers) operated by each of the plurality of online shopping sites. As illustrated in FIG. 2, the interactive dialog editor software can, for example, present a retailer with a series of predetermined software-based forms 20 that prompt a user to enter a series of text-format questions (e.g., Question 1), associated expected answers (e.g., Ans11, Ansl2 etc.) and associated actions (e.g., Act11, Actl2 etc.) to be taken. For ease of use, text-format product questions can be limited to a certain number (e.g., 10). As shown in FIG. 3, the interactive dialog software can also prompt a retailer to supply pictures (e.g., Picture1, Picture2, etc.) of target products (e.g., Product1, Product2, etc.) using conventional picture pasting methodologies and HTML protocol. In this manner, target products to accompany the series of text-format product questions, associated expected answers and associated actions to be taken can be generated. The text-format product questions, associated expected answers, associated actions to be taken and target products that are generated for each of the plurality of online shopping sites can be stored, for example, in a database (not shown) included in dialog editor 106 on server computer 102.

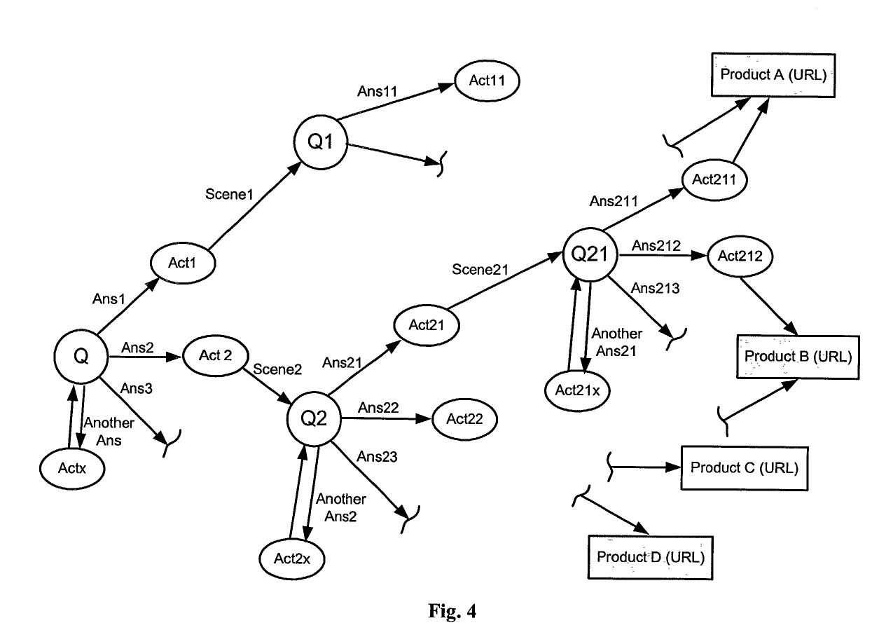

The entire series of text-format product questions, associated expected answers, associated actions to be taken and target products form a branching pathway (or network) that is employed by the computer system to determine the end user's product requirements and a target product that meets those requirements. FIG. 4 depicts a branching pathway relationship between text-format product questions (e.g., Q, Q1, Q2, Q21 etc.), associated expected answers (e.g., Ans1, Ans2, Ans3, etc.), associated actions (e.g., Act1, Act2, etc.) to be taken and target products (Product A, Product B, Product C, Product D etc.) in accordance with one exemplary embodiment of the present invention. The branching pathway relationship between these questions, answers and actions enables the computer system to determine a target product that meets specified requirements, in particular, the end user's product requirements as communicated via voice-format answers to voice-format product questions.

Dialog editor 106 can also be configured to create a custom clerk character image and a scene image associated with each of the text-format product questions and associated expected answers. In this circumstance, dialog interpreter interface 110 (explained in more detail below) displays the clerk character image and scene image on the end user's Internet-enabled device to accompany voice-format product questions.

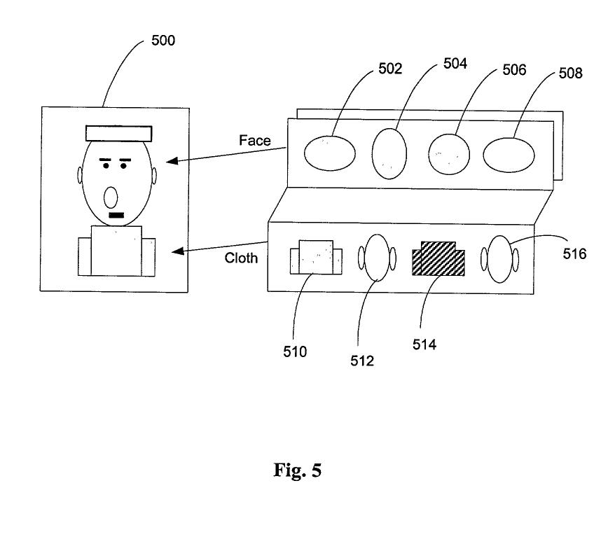

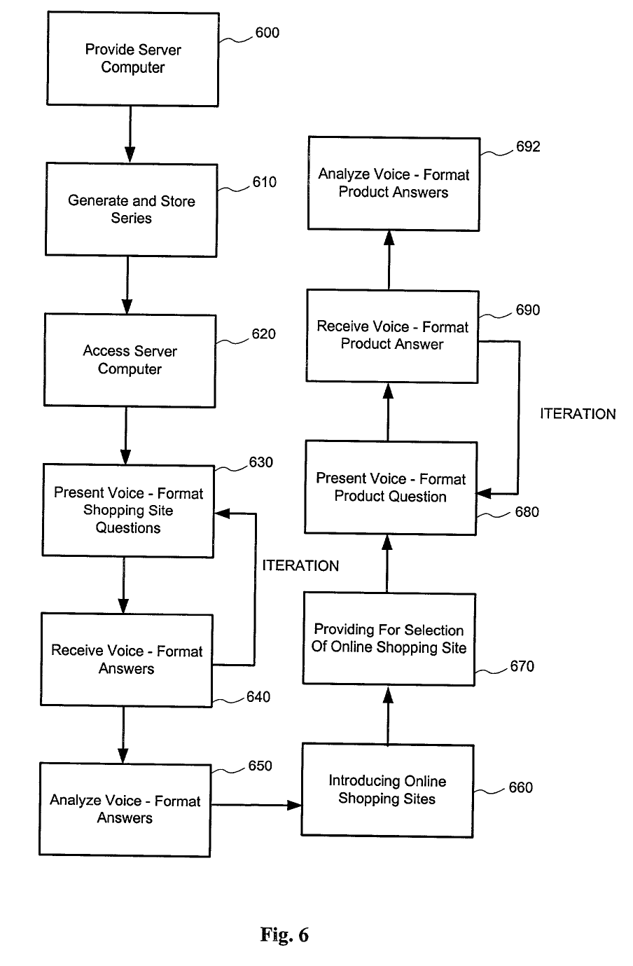

As illustrated in FIG. 5, dialog editor 106 can provide for creation of a custom clerk character image 500 and a scene image (not shown, but noted as scene1, scene2, and scene 21 in FIG. 4) by providing a selection of predetermined clerk image components and scene images. The predetermined clerk image components can include, for example, various clerk faces 502, 504, 506 and 508, and clothes 510, 512, 514 and 516, as well as various types of hair, eyes, noses, mouths, etc. (not shown).

Dialog editor 106 can also be configured to compose a home page for each of the plurality of online shopping sites and to check (i.e., debug) the series of text-format product questions, associated expected answers, associated actions to be taken and target products for logical consistency of the branching pathway. Using dialog editor 106, a series of text-format product questions, associated expected answers, associated actions to be taken and target products can be generated for each of the plurality of online shopping sites by the individual retailers responsible for each of the online shopping sites. By employing dialog editor 106 (either operating entirely on the server computer of the computer system or in part remotely via downloadable interactive dialog editor software), retailers can easily deploy a voice-recognition-based Internet shopping interface. Thus, the retailers are spared the expense, associated with developing the complex software or installing the high performance hardware, required to develop and deploying stand-alone voice recognition technology and character image and scene image creation methodologies.

Text-to-voice converter 108 is configured to convert the text-format product questions generated and stored by dialog editor 106 to voice-format product questions.

Dialog interpreter interface 110 is configured to present an end user with voice-format product questions pertaining to an online shopping site that meets the end user's online shopping site requirements. These voice-format product questions are presented via the end user's Internet-enabled device. Dialog interpreter interface 110 is also configured to receive the end user's voice-format product answers in response to the provided voice-format product questions, to convert them to text-format product answers using voice-recognition technology and to analyze the text-format product answers to determine the end user's product requirements and a target product that meets those requirements. The analysis and determination are essentially accomplished by presenting the end user with a voice-format question, receiving a voice-format product answer thereto and then taking the appropriate action (either presenting the end user with another voice-format product question or a target product) based on the associated expected answers and associated actions to be taken generated by dialog editor 106. The manner in which this process leads to a determination of a target product that meets the end user's product requirement is evident by reference to FIG. 4.

Dialog interpreter interface 110 can optionally include a memory for storing end user information associated with each on-line shopping site with which the end user has interacted (e.g., a history of products purchased from each on-line shopping site). The end user information can be used by dialog interpreter interface 110 to aid in the determination of the end user's product requirements and target product during the end user's use of computer system 100.

Any suitable voice-recognition technology known to one skilled in the art can be employed to convert the end user's voice-format answers (either in response to a voice-format shopping site question or a voice-format product question) to text-format answers, as well as in the text-to-voice converter. The voice-recognition technology does not necessarily have to provide for an absolute one-to-one translation between a voice-format word and a text-format word. Instead, computer systems in accordance with the present invention can be simplified by employing a voice-recognition technology that includes a Natural-Language-Interface (NLI) to ascertain the end user's online shopping site and product requirements without resorting to a one-to-one translation of the end user's voice-format answers. One skilled in the art will recognize that such an NLI can employ, for example, grammatical and/or dictionary feedback methodologies.

Agent interface 104, dialog editor 106, text-to-voice converter 108 and dialog interpreter interface 110 can, for example, be implemented using computer software stored on server computer 102. Computer programming languages and web page protocols known to those skilled in the art, such as C, C++, HTML (“HyperText Markup Language”) and JavaScript, can be used for such implementation. It is recognized, however, that any suitable computer programming language or web page protocol can be used, including custom programs.

The computer system also includes an online shopping site link interface 112 for selectively linking, via Internet connections 18, end user's Internet-enabled device 10 to one or more of the plurality of online shopping sites based on the end user's online shopping site requirements. Furthermore, the computer system includes a transaction facilitator 114 for facilitating (i.e., assisting) the purchase of a target product by an end user. Transaction facilitator 114 can assist in the collection of, for example, credit card, debit card, other payment information, credit verification and shipping information. Both online shopping site link interface 112 and transaction facilitator 114 can be implemented using computer software stored on the server computer 102.

FIG. 6 is a flow diagram illustrating an exemplary embodiment method according to the present invention that provides a voice-recognition-based Internet shopping interface between an end user's Internet-enabled device and a plurality of online shopping sites. The method includes providing a server computer with a dialog editor, an agent interface, a text-to-voice converter and a dialog interpreter interface, as shown at step 600. The agent interface provided in step 600 can include agent plug-in software that is downloadable to the end user's Internet-enabled device.

Next, a series of text-format product questions, associated expected answers, associated actions to be taken and target products for each of the plurality of online shopping sites are generated and stored using the dialog editor, as illustrated at step 610. This series is designed to determine an end user's product requirements by being arranged, for example, in a branching pathway relationship, as illustrated in FIG. 4.

The server computer is then accessed via the end user's Internet-enabled device and a series of voice-format shopping site questions is presented to the end user (via the end user's Internet-enabled device) using the agent interface, as shown at steps 620 and 630. The accessing of the server computer can, for example, be accomplished at least in part by downloading the agent plug-in software to the end user's Internet-enabled device. Next, the end user's voice-format answers to the voice-format shopping site questions are received at the agent interface (see step 640) and analyzed (see step 650) to determine the end user's online shopping site requirements. As evident from FIG. 6, the presenting of voice-format shopping site questions and the receiving of voice-format answers thereto can be an iterative process.

Online shopping sites that meet the end user's online shopping site requirements are subsequently introducing to the end user via the end user's Internet-enabled device, as shown at step 660. The end user subsequently selects one of the online shopping sites that meets the end user's online shopping site requirements, as illustrated at step 670.

Next, voice-format product questions (which are generated by the text-to-voice converter from the series of text-format product questions) are presented to the end user via the end user's Internet-enabled device (see step 680), and then the end user's voice-format answers thereto are received at the dialog interpreter (see step 690). As indicated in FIG. 6, the presenting of voice-format product questions and the receiving of voice-format product answers can be an iterative process. The dialog interpreter then analyzes the voice-format answers to the voice-format product questions, using the generated associated expected answers, associated actions to be taken and target products, to determine the end user's product requirements and a target product that meets those requirements (see step 692).

If desired, the dialog editor can include downloadable dialog editor software. The series of text-format product questions, associated expected answers, associated actions to be taken and target products for at least one of the plurality of online shopping sites can then be generated at a remote computer. Furthermore, the presentation of voice-format shopping site questions and voice-format product questions can be accompanied by displaying an agent character image and a clerk character image, respectively, on the end user's Internet-enabled device..

It should be understood that various alternatives to the embodiments of the invention described herein may be employed in practicing the invention. It is intended that the following claims define the scope of the invention and that structures and methods within the scope of these claims and their equivalents be covered thereby.

What is claimed is:

1. Computer system for providing a voice-recognition-based Internet shopping interface between an end user's Internet-enabled device and a plurality of online shopping sites, the computer system comprising:
a server computer linked to the Internet, the server computer including:
an agent interface for analyzing and determining an end user's online shopping site requirements by presenting a series of voice-format shopping site questions to an end user via the end user's Internet-enabled device, receiving voice-format answers thereto via the end user's internet-enabled device, converting the voice-format answers to text-format answers using a voice-recognition technology, and analyzing the text-format answers to determine the end user's online shopping site requirements;
a dialog editor for generating and storing a series of text-format product questions, associated expected answers, associated actions to be taken and target products for each of the plurality of online shopping sites in order to determine the end user's product requirements;
a text-to-voice converter for converting the text-format product questions to voice-format product questions; and
a dialog interpreter interface for presenting the end user with voice-format product questions pertaining to an online shopping site that meets the end user's online shopping site requirements via the end user's Internet-enabled device, receiving voice-format product answers thereto via the end user's Internet-enabled device, converting the voice-format product answers to text-format product answers using the voice-recognition technology, and analyzing the text-format product answers to determine an end user's product requirements and a target product that meets the end user's product requirements.

2. The computer system of claim 1 further including:
an online shopping site link interface for selectively linking, via the Internet, an end user's Internet-enabled device to one or more of the plurality of online shopping sites based on the end user's online shopping site requirements.

3. The computer system of claim 1 further comprising an end user's Internet-enabled device that is selected from the group consisting of an Internet-enabled personal digital assistant, an Internet-enabled personal computer, an Internet-enabled cellular phone, and an interactive television.

4. The computer system of claim 1, wherein the agent interface includes a database of the plurality of online shopping sites.

5. The computer system of claim 4, wherein the agent interface includes a database search engine for searching the database.

6. The computer system of claim 1, wherein the agent interface includes agent plug-in software downloadable to the end user's Internet-enabled device.

7. The computer system of claim 1, wherein the agent interface includes an agent interface memory for storing an end user's profile and an end user's on-line shopping history.

8. The computer system of claim 1, wherein the agent interface is further configured to display an agent character image on the end user's Internet-enabled device.

9. The computer system of claim 1, wherein the dialog editor generates the series of text-format product questions, associated expected answers, associated actions to be taken and target products for each of the plurality of online shopping sites by employing predetermined software-based forms.

10. The computer system of claim 9, wherein the dialog editor provides for the series of series of text-format product questions, associated expected answers, associated actions to be taken and target products for each of the plurality of online shopping sites to be generated remotely using interactive dialog editor software downloaded from the server computer.

11. The computer system of claim 10, wherein the dialog editor provides for the series of text-format product questions, associated expected answers, associated actions to be taken and target products for each of the plurality of online shopping sites to be stored remotely using the interactive dialog editor software downloaded from the server computer.

12. The computer system of claim 1, wherein the dialog editor further creates a clerk character image and a scene image associated with each of the text-format product questions and associated expected answers; and wherein the dialog interpreter interface displays the clerk character image and scene image on the end user's Internet-enabled device to accompany the text-format product questions and associated expected answers.

13. The computer system of claim 12, wherein the dialog editor further creates a clerk character image and a scene image by providing a selection of predetermined clerk image components and predetermined scene images.

14. The computer system of claim 1, wherein the dialog interpreter interface includes a memory for storing end user information.

15. The computer system of claim 1 further comprising a transaction facilitator for facilitating the purchasing of a target product by the end user.

16. The computer system of claim 1, wherein the voice-recognition technique includes a natural language interface.

17. The computer system of claim 1, wherein the series of text-format questions, associated expected answers, associated actions to be taken and target products for each of the plurality of online shopping sites are stored on the server computer.

18. The computer system of claim 1, wherein the dialog generator, agent interface and dialog interpreter interface include software programs stored on the server computer.

19. A method for providing a voice-recognition-based Internet shopping interface between an end user's Internet-enabled device and a plurality of online shopping sites, the method comprising:
providing a server computer with a dialog editor, an agent interface, a text-to-voice converter and a dialog interpreter interface;
generating and storing a series of text-format product questions, associated expected answers, associated actions to be taken and target products for each of the plurality of online shopping sites for determining product requirements of the end user using the dialog editor;
accessing the server computer via the end user's Internet-enabled device;
presenting voice-format shopping site questions to the end user via the end user's Internet-enabled device using the agent interface;
receiving voice-format answers to the voice-format shopping site questions at the agent interface;
analyzing the voice-format answers to the voice-format shopping site questions to determine the end user's online shopping site requirements;
introducing to the end user, via the end user's Internet-enabled device, online shopping sites that meet the end user's online shopping site requirements;
providing for the end user to select one of the online shopping sites that meet the end user's online shopping site requirements;
presenting voice-format product questions to an end user via the end user's Internet-enabled device, the voice-format product questions generated by the text-to-voice converter from the series of text-format product questions;
receiving voice-format product answers to the voice-format product questions at the dialog interpreter; and
analyzing the voice-format product answers to the voice-format product questions, using the associated expected answers, associated actions to be taken and target products, to determine the end user's product requirements and a target product that meets the end user's product requirements.

20. The method of claim 19 further comprising, during the first providing step, providing a server computer with an agent interface wherein the agent interface includes agent plug-in software and, wherein the accessing of the server computer is accomplished at least in part by downloading the agent plug-in software to the end user's Internet-enabled device.

21. The method of claim 19 wherein the step of providing a server computer with a dialog editor includes providing a dialog editor with downloadable dialog editor software and wherein the generating of the series of text-format product questions, associated expected answers, associated actions to be taken and target products for at least one of the plurality of online shopping sites is accomplished at a remote computer using downloaded dialog editor software.

22. The method of claim 19, wherein the step of presenting voice-format shopping site questions is accompanied by the display of an agent character image on the end user's Internet-enabled device.

23. The method of claim 19, wherein the step of presenting voice-format product question is accompanied by the display of a clerk character image on the end user's Internet-enabled device.
